(19) United States
(12) Patent Application Publication
(10) Pub. No.: US 2009/0146924 A1
(43) Pub. Date: Jun. 11, 2009

(54) DISPLAY APPARATUS AND METHOD THEREOF

(75) Inventor: Woo-sub CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/191,696

(22) Filed: Aug. 14, 2008

(30) Foreign Application Priority Data
Dec. 7, 2007 (KR) 10-2007-0127074

(51) Int. Cl. G09G 3/28

(52) U.S. Cl. 345/60

(57) ABSTRACT

A display apparatus and a method use a driving signal containing plural types of waveforms. The display apparatus includes a display, a first waveform generating unit which generates a first waveform, a second waveform generating unit which generates a second waveform, a switching unit which switches to select one of the first and second waveforms generated at the first and second waveform generating units, and a control unit which controls the switching unit so that a driving signal containing the waveforms, which are selected through a plurality of number of switching operations at the switching unit, to the display. Since various types of voltage are applied to a system, without having to use a plurality of separate power sources and switching elements, an integrated circuit, and simpler design and components, are achieved.

### CROSS-REFERENCE TO RELATED APPLICATION

This application claims priority from Korean Patent Application No. 2007-0127074, filed Dec. 7, 2007 in the Korean Intellectual Property Office, the entire disclosure of which is hereby incorporated by reference.

### BACKGROUND OF THE INVENTION

1. Field of the Invention

Apparatuses and methods consistent with the present invention relate to a display apparatus, and more particularly, to a display apparatus and a method thereof, using a plurality of waveforms.

2. Description of the Related Art

Planar displays are widely used in portable devices, and are rapidly replacing cathode ray tube (CRT) displays in the field of large displays.

Among the planar displays, the plasma display panel (PDP) has the advantages of high brightness and light efficiency, and wider view range.

The PDP uses the light generated from the plasma of the ionized gas, to display texts or graphics. There are mainly DC type and AC type PDPs, and among these, the address display period separation (ADS)-based AC type PDP using surface discharge, is more commercialized and popularly used.

The AC type PDP employs a matrix of cells. Each of the cells is surrounded by the front and back substrates and partition, and excited to generate a light, as a voltage is added to the three electrodes (Y-electrode, X-electrode, and data electrode).

In the ADS driving manner, each sub field of a display panel is divided into a reset region, address region, and sustain region to be driven individually.

Due to the reset region, the wall charge is removed from the sustain, and setup to stably perform the following address discharge.

In the address region, the lighting cells (or addressed cells) and non-lighting cells are selected so that the wall charge is accumulated in the addressed cells.

In the sustain region, the sustain voltage is alternately added to the Y and X electrodes, to begin discharge to display an image on the addressed cells.

As explained above, the PDP generates discharge using a voltage difference of pulse waves between Y and X electrodes, and drives a display panel using the light generated from the discharge-generated plasma. Accordingly, voltages in various patterns are necessary to drive the display panel.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus and a method thereof, capable of selectively using a plurality of waveforms with a single driving element and outputting waveforms in various forms.

According to an aspect of the present invention, there is provided a display apparatus including a display, a first waveform generating unit which generates a first waveform, a second waveform generating unit which generates a second waveform, a switching unit which switches to select one of the first and second waveforms generated at the first and second waveform generating units, and a control unit which controls the switching unit so that a driving signal containing the waveforms, which are selected through a plurality of number of switching operations at the switching unit, to the display.

The driving signal may include a Y-driving signal to be input to a Y-electrode of the display.

The first waveform generating unit may include a first input signal receiving unit which receives a first input signal to generate the first waveform, and a first waveform converting unit which converts the first input signal into the first waveform, and the second waveform generating unit may include a second input signal receiving unit which receives a second input signal to generate the second waveform, and a second waveform converting unit which converts the second input signal into the second waveform.

The first and second waveforms have a first and second time constants, respectively, which are changeable.

The first waveform is a ramp waveform having a first slope, and the second waveform is a ramp waveform having a second slope.

According to another aspect of the present invention, the display apparatus may further include a third waveform generating unit which converts the first or second waveform into a third waveform, and wherein the switching unit switches to select one of the first waveform generated at the first waveform generating unit, the second waveform generated at the second waveform generating unit, and the third waveform generated at the third waveform generating unit.

The first and second waveforms are ascending waveforms, and the third waveform is a descending waveform.

According to yet another aspect of the present invention, there is provided a display method including generating a first waveform, generating a second waveform, and driving, with one switching element, a display using a driving signal containing waveforms selected from plural numbers of switching operations performed to select one of the first and second waveforms.

The driving signal may include a Y-driving signal to be input to a Y-electrode of the display.

The first waveform generating may include receiving a first input signal to generate the first waveform, and converting the first input signal into the first waveform, and the second waveform generating may include receiving a second input signal to generate the second waveform; and converting the second input signal into the second waveform.

The first and second waveforms have a first and second time constants, respectively, which are changeable.

The first waveform is a ramp waveform having a first slope, and the second waveform is a ramp waveform having a second slope.

According to yet another aspect of the present invention, the display method may further include converting the first or second waveform into a third waveform, and wherein the driving the display comprises causing one of the generated first, second and third waveforms to be selected according to the switching.

The first and second waveforms are ascending waveforms, and the third waveform is a descending waveform.

According to yet another aspect of the present invention, a display apparatus is provided, including a signal receiving unit which receives a plurality of input signals, a waveform generating unit which generates a plurality of waveforms using the plurality of input signals, and a switching unit which generates a set of signals, by iterating selecting one from among the plurality of waveforms generated by the waveform generating unit.

The waveform generating unit generates the plurality of waveforms by adjusting time constants of the plurality of input signals.

The display apparatus may further include a driving unit which drives a display, and wherein the set of signals are driving signals for the driving unit to drive the display.

According to yet another aspect of the present invention, a display apparatus is provided, including a signal receiving unit which receives a plurality of input signals, a waveform converting unit which provides a plurality of waveforms to generate a driving signal, by adjusting time constants of the plurality of input signals, a switching unit which generates a driving signal using the plurality of waveforms provided by the waveform converting unit, and a driving unit which drives a display using the driving signal output from the switching unit.

According to yet another aspect of the present invention, a display method is provided, including receiving a plurality of input signals, generating a plurality of waveforms using the plurality of input signals, and generating a set of signals, by iterating selecting one from among the plurality of waveforms generated by the waveform generating unit.

The generating the plurality of waveforms generates the plurality of waveforms by adjusting time constants of the plurality of input signals.

The set of signals are driving signals for the driving unit to drive the display.

According to yet another aspect of the present invention, a display method is provided, including receiving a plurality of input signals, providing a plurality of waveforms to generate a driving signal, by adjusting time constants of the plurality of input signals, generating a driving signal using the plurality of waveforms provided by the waveform converting unit, and driving a display using the driving signal output from the switching unit.

### BRIEF DESCRIPTION OF THE DRAWINGS

The above and other aspects of the present invention will be more apparent from the following detailed description of exemplary embodiments with reference to the accompanying drawings, in which:

FIG. 1 is a block diagram of a broadcast receiving apparatus according to an exemplary embodiment of the present invention;

FIG. 2 is a block diagram of a video output unit;

FIGS. 3A and 3B illustrate the operation of a Y-driving signal generating unit;

FIG. 4 illustrates the process of generating a Y-driving signal;

FIG. 5 is a flowchart illustrating a display method according to an exemplary embodiment of the present invention; and

FIG. 6 is a circuit diagram of a Y-driving signal generating unit.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

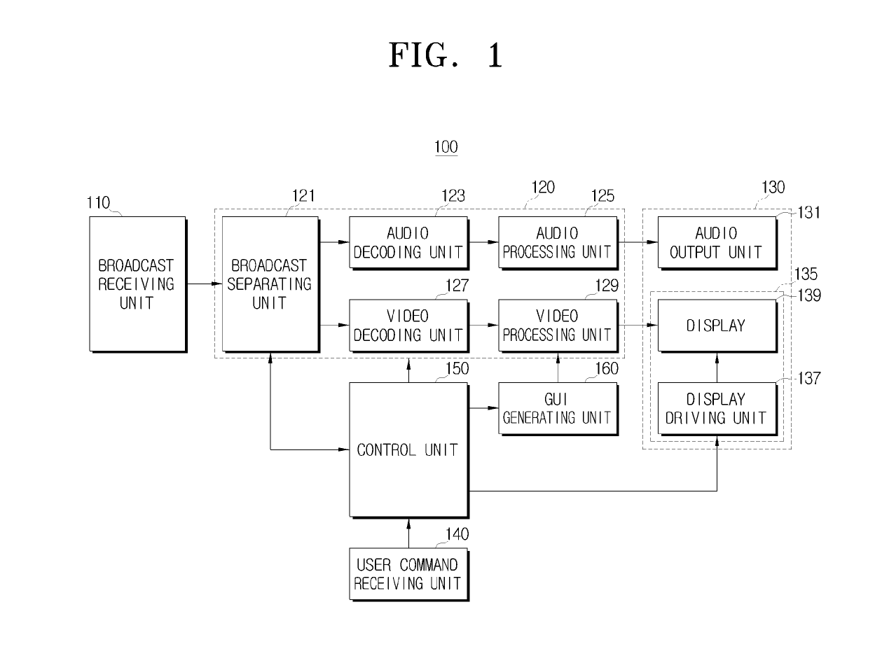

FIG. 1 is a block diagram of a broadcast receiving apparatus 100 according to an exemplary embodiment of the present invention. The broadcasting receiving apparatus 100 is capable of providing viewers with a viewable video.

Referring to FIG. 1, the broadcast receiving apparatus 100 according to an exemplary embodiment of the present invention includes a broadcast receiving unit 110, a broadcast processing unit 120, a broadcast output unit 130, a user command receiving unit 140, a control unit 150, and a graphic user interface (GUI) generating unit 160.

The broadcast receiving unit 110 tunes to one of broadcasts received by wired or wireless manner and decodes the received signal.

The broadcast processing unit 120 processes the broadcast signal output from the broadcast receiving unit 1 10. The broadcast processing unit 120 includes a broadcast separating unit 121, an audio decoding unit 123, an audio processing unit 125, a video decoding unit 127, and a video processing unit 129.

The broadcast separating unit 121 separates a broadcast signal received from the broadcast receiving unit 110 into a video signal and an audio signal.

The audio decoding unit 123 decodes an audio signal output from the broadcast separating unit 121. Accordingly, a decompressed audio signal is output from the audio decoding unit 123.

The audio processing unit 125 converts the decoded audio signal, which is output from the audio decoding unit 123, into a format appropriate for output through a speaker provided at the broadcast receiving apparatus 100.

The video decoding unit 127 decodes the video signal output from the broadcast separating unit 121. Accordingly, a decompressed video signal is output from the video decoding unit 127.

The video processing unit 129 converts the decoded video signal, which is output from the video decoding unit 127, into a video data signal in a format suitable for output, and outputs the converted signal to the video output unit 135. To this end, the video processing unit 129 performs operations such as color signal processing and scaling of the decoded video signal.

The user command receiving unit 140 transfers a user command received through a remote controller to the control unit 150, so that the control unit 150 controls the overall operation of the broadcast receiving apparatus 100 according to the user command received at the user command receiving unit 140.

The GUI generating unit 160 generates a GUI to be displayed on a display. Such generated GUI is applied to the video processing unit 129 and added to a video to be displayed, that is, the GUI is on-screen display (OSD) processed.

The output unit 130 provides the user with a video and audio corresponding to the video and audio signals output from the broadcast processing unit 120. The output unit 130 includes an audio output unit 131 and a video output unit 135.

The audio output unit 131 outputs an audio signal output from the audio processing unit 125 through a speaker.

The video output unit 135 outputs a video signal output from he video processing unit 129. The video output unit 135 includes a display driving unit 137 and a display 139.

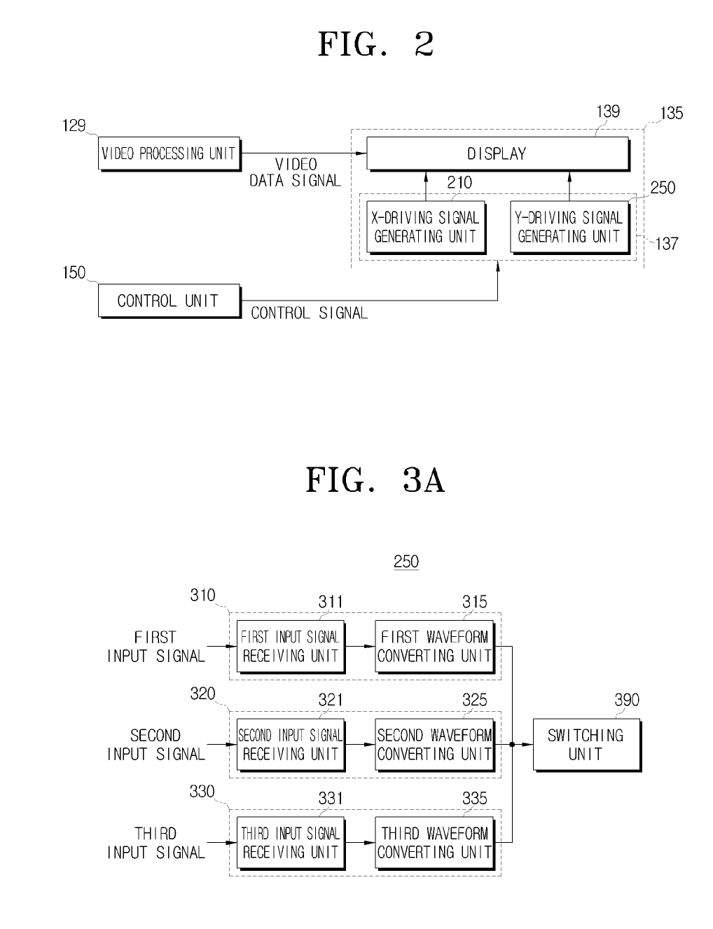

The detailed structure of the video output unit 135 will be explained below with reference to FIG. 2.

FIG. 2 is a block diagram of the video output unit 135 according to an exemplary embodiment of the present invention, which further includes a video processing unit 129 and a control unit 150, in addition to the display driving unit 137 and the display 139.

The display driving unit 137 generates a driving signal to drive the display 139, and outputs the generated signal to the display 139. Referring to FIG. 2, the display driving unit 137 includes an X-driving signal generating unit 210 and a Y-driving signal generating unit 250.

The X-driving signal generating unit 210 receives a control signal from the control unit 150, generates an X-driving signal to drive an X-electrode, and outputs the generated X-driving signal to the display 139.

The Y-driving signal generating unit 250 receives a control signal from the control unit 150, generates a Y-driving signal to drive a Y-electrode, and outputs the generated Y-driving signal to the display 139.

The display 139 outputs a video, using the X-driving signal and the Y-driving signal received from the display driving unit 139, and the video data signal received from the video processing unit 129.

The display 139 outputs a video using the discharge generated among the X-electrode, Y-electrode and address electrode. The X-electrode, Y-electrode, and address electrode are driven by the X-driving signal, Y-driving signal, and video data signal.

The video output unit 135 outputs a video signal received from the video processing unit 129.

Referring back to FIG. 1, the control unit 150 controls the overall operation of the broadcast receiving apparatus 100. Specifically, the control unit 150 controls the broadcast processing unit 120, the GUI generating unit 160, and the display driving unit 137 to provide a viewer with a broadcast program.

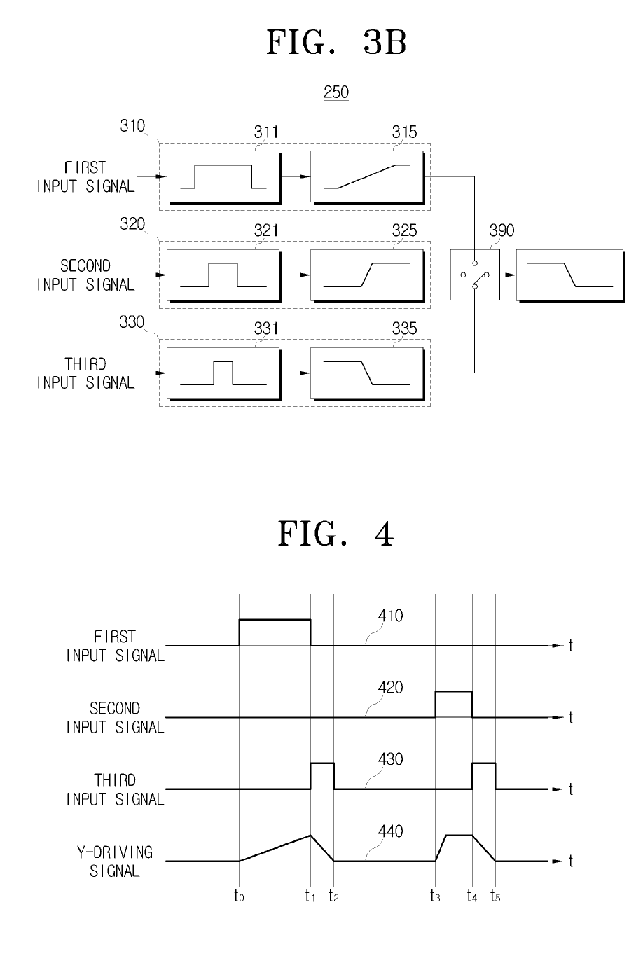

Specifically, the control unit 150 controls the display driving unit 137 to generate a Y-driving signal having a predetermined waveform. In order to explain the process of generating a Y-driving signal, it is necessary to explain the Y-driving signal generating unit 250 first. Referring to FIGS. 3A and 3B, the process of generating a Y-driving signal is explained.

FIGS. 3A and 3B illustrate the operation of the Y-driving signal generating unit 250 according to an exemplary embodiment of the present invention. Specifically, FIG. 3A illustrates the operation of the Y-driving signal generating unit 250 based on blocks, and FIG. 3B illustrates the operation of the Y-driving signal generating unit 250 based on the shapes of waveforms.

The two examples of the Y-driving signal generating unit 250 will be explained below with reference to FIGS. 3A and 3B, in which the Y-driving signal generating unit is referred to by the same reference numeral ‘250’ for convenience of the explanation.

The Y-driving signal generating unit 250 includes a first waveform generating unit 310, a second waveform generating unit 320, a third waveform generating unit 330, and a switching unit 390.

The first waveform generating unit 310 generates a first waveform to be output through a switching unit 390, which will be explained below, using a first input signal. The first waveform generating unit 310 includes a first input signal receiving unit 311 and a first waveform converting unit 315.

The first input signal receiving unit 311 receives the first input signal and determines whether or not to transfer the first input signal to the first waveform converting unit 315 by switching.

If the first input signal receiving unit 311 switches to transfer the first input signal to the first waveform converting unit 315, the first waveform converting unit 315 converts the first input signal, which is received through the first input signal receiving unit 311, into a ramp waveform by charging a voltage.

The first waveform converting unit 315 has a predetermined time constant to convert the input signal into a ramp waveform having a predetermined slope. The time constant set in the first waveform converting unit 315 may be varied by a user.

Accordingly, the first waveform converting unit 315 transfers the first input signal, converted into the ramp waveform, to the switching unit 390.

The second waveform generating unit 320 generates a second waveform to be output from the switching unit 390, using the second input signal. The second waveform generating unit 320 includes a second input signal receiving unit 321 and a second waveform converting unit 325.

The second input signal receiving unit 321 receives the second input signal, and determines, by switching, whether or not to transfer the second input signal to the second waveform converting unit 325.

If the second input signal receiving unit 321 switches to transfer the second input signal to the second waveform converting unit 325, the second waveform converting unit 325 converts the second input signal, received through the second input signal receiving unit 321, into a square waveform, by the voltage charging of the second waveform converting unit 325.

The second waveform converting unit 325 has a predetermined time constant to convert the input signal into a square waveform signal having a steep slope. The time constant set in the second waveform converting unit 325 may be altered by a user. As a result, the second waveform converting unit 325 transfers the second input signal, converted into a square waveform, to the switching unit 390.

The first waveform converting unit 315 and the second waveform converting unit 325 each generate ascending waveforms using the first and second input signals. Specifically, the first waveform converting unit 315 generates a ramp-up waveform having a smooth slope, and the second waveform converting unit 325 generates an ascending square waveform having a steep slope.

The third waveform generating unit 330 generates a third waveform to be output from the switching unit 390, using the third input signal.

The third waveform generating unit 330 includes a third input signal receiving unit 331, and a third waveform converting unit 335.

The third input signal receiving unit 331 receives the third input signal, and determines, by switching, whether or not to output a predetermined waveform from the switching 390.

The third waveform converting unit 335 operates to generate a waveform to be output from the switching 390, in a significantly different manner from those of the first and second waveform converting units 315 and 325.

If the third input signal receiving unit 331 determines, by switching, that a predetermined waveform will be output from the switching unit 390, the third waveform converting unit 335 causes the ascending waveform signal to descend through the charging at the first or the second waveform converting unit 315 or 325.

The third waveform converting unit 335 has a predetermined time constant to cause a signal to turn to a descending waveform having a predetermined slope. The time constant predetermined in the third waveform converting unit 335 may be altered by a user.

As explained above, unlike the first and second waveform converting units 315 and 325, the third waveform converting unit 335 converts the ascending waveform signals of the first and second waveform converting units 315 and 325 into a descending pattern, so that the switching unit 390 outputs the resultant descending waveform signals.

The switching unit 390 switches to select one of the waveforms generated by the first, second and third waveform generating units 310, 320 and 330. The switching unit 390 performs a predetermined number of switching, and generates a Y-driving signal using a plurality of waveforms generated by the switching. Additionally, the switching unit 390 transfers the generated Y-driving signal to the display 139.

FIG. 4 illustrates the process of generating a Y-driving signal. Referring to FIG. 4, the first, second and third input signals are input based on a time axis, and the Y-driving signal is generated using the first, second and third input signals.

The first input signal is input to the first waveform generating unit 310 for the duration of time from 0 to t1. The first waveform generating unit 310 converts the first input signal into a signal having a ramp-up waveform, and outputs the converted signal to the switching unit 390. If the switching unit 390 selects a signal output from the first waveform generating unit 310 for the duration of time t0 to t1, the signal output from the first waveform generating unit 310 is also output from the switching unit 390.

The second input signal is input to the second waveform generating unit 320 for the duration of time t3 to t4. The second waveform generating unit 320 converts the second input signal into a signal having an ascending square waveform, and outputs the converted signal to the switching unit 390. If the switching unit 390 selects the signal output from the second waveform generating unit 320 for the duration of time t3 to t4, the signal output from the second waveform generating unit 320 is also output from the switching unit 390.

The third input signal is input to the third waveform generating unit 330 for the durations of time t1 to t2, and t4 to t5. The third waveform generating unit 330 converts the third input signal into a signal having a descending waveform, and outputs the converted signal to the switching unit 390. If the switching unit 390 selects the signal output from the third waveform generating unit 330 for the durations of time t1 to t2, and t4 to t5, the signal output from the third waveform generating unit 330 is also output from the switching unit 390.

As a result, the Y-driving signal is generated.

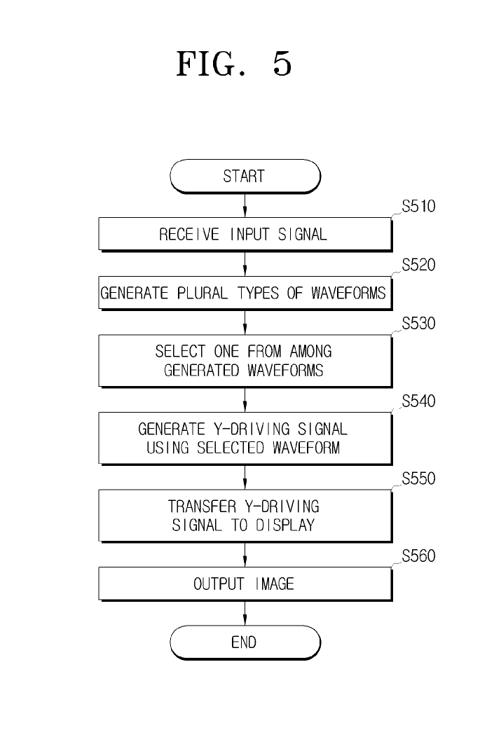

FIG. 5 is a flowchart to illustrate a display method according to an exemplary embodiment of the present invention.

At operation S510, the first, second, and third waveform generating units 310, 320, and 330 receive the first, second and third input signals, respectively.

At operation S520, the first, second and third waveform generating units 310, 320, and 330 generate ramp-up waveform, square waveform, and descending waveform, using the first, second, and third input signals, respectively.

At operation S530, the switching unit 390 selects one of the generated waveforms, and at operation S540, generates a Y-driving signal using the selected waveforms.

At operation S550, if the Y-driving signal is generated, the switching unit 390 transfers the Y-driving signal to the display 139.

At operation S560, the display 139 outputs a video using the Y-driving signal.

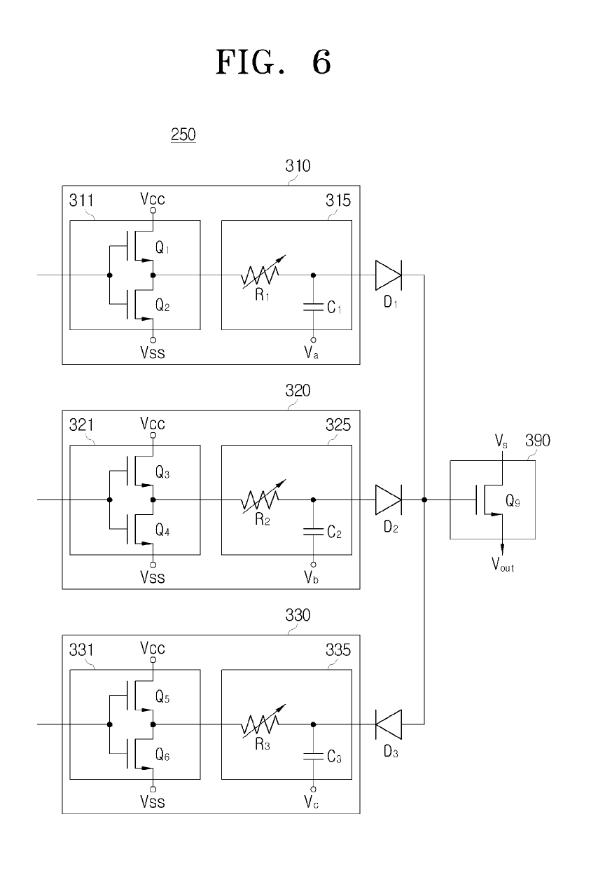

FIG. 6 is a circuit diagram of the Y-driving signal generating unit 250.

As explained above with reference to FIGS. 3A and 3B, the Y-driving signal generating unit 250 includes the first, second and third waveform generating units 310, 320, and 330, and the switching unit 390. The first waveform generating unit 310 includes the first input signal receiving unit 311 and the first waveform converting unit 315, the second waveform generating unit 320 includes the second input signal receiving unit 321 and the second waveform converting unit 325, and the third waveform generating unit 330 includes the third input signal receiving unit 331 and the third waveform converting unit 335.

The operations of the first, second and third waveform generating units 310, 320, and 330 will be explained in detail below, based on the operation of the first waveform generating unit 310.

The first input signal receiving unit 311 includes a first transistor Q1 and a second transistor Q2. The first and second transistors Q1 and Q2 together receive the first input signal through a gate, and determine whether or not to transfer the received first input signal to the first waveform converting unit 315.

Specifically, if the first transistor Q1 switches on, the first input signal receiving unit 311 transfers the first input signal to the first waveform converting unit 315, and if the first transistor Q2 switches off, the first input signal receiving unit 311 does not transfer the first input signal to the first waveform converting unit 315.

If the second transistor Q2 switches on, the first input signal receiving unit 311 receives a signal from the first waveform converting unit 315, and if the second transistor Q2 switches off, the first input signal receiving unit 311 does not receive a signal from the first waveform converting unit 315.

The first waveform converting unit 315 includes a resistor and a capacitor, and generates a time constant using the resistor and capacitor. According to an aspect of the present invention, a time constant ‘1/(R1*C1)’ is generated in the first waveform converting unit 315. The first waveform converting unit 315 generates a signal in a ramp-up waveform based on the generated time constant ‘1/(R1*C1),’ using the input signal output from the first input signal receiving unit 311.

The first waveform converting unit 315 then transfers the ramp-up waveform signal based on time constant ‘1/(R1*C1)’ to the switching unit 390.

The variable resistor R1 is used to change the time constant using a resistance.

A diode D1 may be arranged between the first waveform generating unit 310 and the switching unit 390, to prevent ingress of a waveform into the first waveform generating unit, if the first transistor Q1 switches off and the second transistor Q2 switches on.

The second and third waveform generating units 320 and 330 basically operate with the same operation principle as that of the first waveform generating unit 310. The only difference is that the second waveform generating unit 320 generates an ascending square waveform to transfer to the switching unit 390, and the third waveform generating unit 330 generates a descending waveform to transfer to the switching unit 390.

A diode D3 may also be disposed between the third waveform generating unit 330 and the switching unit 390, to help the third waveform generating unit 330 to receive a signal output from the first and second waveform generating units 310 and 320.

The switching unit 390 may be implemented as a transistor. The transistor of the switching unit 390 receives the waveforms generated at the first, second and third waveform generating units 310, 320 and 330, and outputs a waveform selected from among the generated waveforms of the first, second and third waveform generating units 310, 320 and 330.

As a result, the waveforms generated at the respective waveform generating units 310, 320 and 330 can be selectively output.

Alternatively, the concept of the present invention is applicable to an example in which the respective components of the Y-driving signal generating unit 250 are implemented as separate elements.

While the above exemplary embodiments of the present invention explained the example in which the Y-driving signal generating unit 250 generates three types of waveforms, this is only for the purpose of explanation. Alternatively, the Y-driving signal generating unit 250 may generate two, or more than three types of waveforms.

Furthermore, while the exemplary embodiments of the present invention were explained based on the display apparatus used in a broadcast receiving apparatus, this is only for the purpose of explanation. For example, the concept of the present invention is applicable to a display apparatus which does not receive a broadcast, or alternatively, the Y-driving signal generating unit 250 may be applied to an apparatus or a system other than that a display apparatus, that requires a plurality of types of waveforms.

Furthermore, while the time constant has explained to be changed by varying the resistor, this is only for the purpose of explanation. For example, the time constant can be changed by varying the capacitor.

Furthermore, an inductor may be used instead of, or along with the resistor and the capacitor, to realize a time constant generating unit. In this case too, it is possible that one or some of the resistor, capacitor or inductor is variably implemented.

According to the exemplary embodiments of the present invention explained above, plural types of waveforms are selectively used so that it is possible that waveforms in various patterns are output. Since various types of voltage are applied to a system, without having to use a plurality of separate power sources and switching elements, an integrated circuit, and simpler design and components, are achieved.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A display apparatus comprising:
a display;
a first waveform generating unit which generates a first waveform;
a second waveform generating unit which generates a second waveform;
a switching unit which switches to select one of the first and second waveforms generated at the first and second waveform generating units; and
a control unit which controls the switching unit so that a driving signal containing the waveforms, which are selected through a plurality of number of switching operations at the switching unit, to the display.

2. The display apparatus of claim 1, wherein the driving signal comprises a Y-driving signal to be input to a Y-electrode of the display.

3. The display apparatus of claim 1, wherein the first waveform generating unit comprises:
a first input signal receiving unit which receives a first input signal to generate the first waveform; and
a first waveform converting unit which converts the first input signal into the first waveform, and
the second waveform generating unit comprises,
a second input signal receiving unit which receives a second input signal to generate the second waveform; and
a second waveform converting unit which converts the second input signal into the second waveform.

4. The display apparatus of claim 3, wherein the first and second waveforms have a first and second time constants, respectively, which are changeable.

5. The display apparatus of claim 1, wherein the first waveform is a ramp waveform having a first slope, and the second waveform is a ramp waveform having a second slope.

6. The display apparatus of claim 1, further comprising:
a third waveform generating unit which converts the first or second waveform into a third waveform, and wherein the switching unit switches to select one of the first waveform generated at the first waveform generating unit, the second waveform generated at the second waveform generating unit, and the third waveform generated at the third waveform generating unit.

7. The display apparatus of claim 6, wherein the first and second waveforms are ascending waveforms, and the third waveform is a descending waveform.

8. A display method comprising:
generating a first waveform;
generating a second waveform; and
driving, with one switching element, a display using a driving signal containing waveforms selected from plural numbers of switching operations performed to select one of the first and second waveforms.

9. The display method of claim 8, wherein the driving signal comprises a Y-driving signal to be input to a Y-electrode of the display.

10. The display method of claim 8, wherein the first waveform generating comprises:
receiving a first input signal to generate the first waveform; and
converting the first input signal into the first waveform, and
the second waveform generating comprises,
receiving a second input signal to generate the second waveform; and
converting the second input signal into the second waveform.

11. The display method of claim 10, wherein the first and second waveforms have a first and second time constants, respectively, which are changeable.

12. The display method of claim 8, wherein the first waveform is a ramp waveform having a first slope, and the second waveform is a ramp waveform having a second slope.

13. The display method of claim 8, further comprising:
converting the first or second waveform into a third waveform, and wherein the driving the display comprises causing one of the generated first, second and third waveforms to be selected according to the switching.

14. The display method of claim 13, wherein the first and second waveforms are ascending waveforms, and the third waveform is a descending waveform.

15. A display apparatus, comprising:
a signal receiving unit which receives a plurality of input signals;
a waveform generating unit which generates a plurality of waveforms using the plurality of input signals; and
a switching unit which generates a set of signals, by iterating selecting one from among the plurality of waveforms generated by the waveform generating unit.

16. The display apparatus of claim 15, wherein the waveform generating unit generates the plurality of waveforms by adjusting time constants of the plurality of input signals.

17. The display apparatus of claim 15, further comprising a driving unit which drives a display, and wherein the set of signals are driving signals for the driving unit to drive the display.

18. A display apparatus, comprising:
a signal receiving unit which receives a plurality of input signals;
a waveform converting unit which provides a plurality of waveforms to generate a driving signal, by adjusting time constants of the plurality of input signals;
a switching unit which generates a driving signal using the plurality of waveforms provided by the waveform converting unit; and
a driving unit which drives a display using the driving signal output from the switching unit.

19. A display method, comprising:
receiving a plurality of input signals;
generating a plurality of waveforms using the plurality of input signals; and
generating a set of signals, by iterating selecting one from among the plurality of waveforms generated by the waveform generating unit.

20. The display method of claim 19, wherein the generating the plurality of waveforms generates the plurality of waveforms by adjusting time constants of the plurality of input signals.

21. The display method of claim 19, wherein the set of signals are driving signals for the driving unit to drive the display.

22. A display method, comprising:
receiving a plurality of input signals;
providing a plurality of waveforms to generate a driving signal, by adjusting time constants of the plurality of input signals;
generating a driving signal using the plurality of waveforms provided by the waveform converting unit; and
driving a display using the driving signal output from the switching unit.
